(19) United States
(12) Patent Application Publication
(10) Pub. No.: US 2012/0287880 A1
(43) Pub. Date: Nov. 15, 2012

(54) RESOURCE ALLOCATION

(75) Inventors: Frank Frederiksen, Klarup (DK); Lars Lindh, Helsingfors (FI)

(73) Assignee: NOKIA CORPORATION, Espoo (FI)

(21) Appl. No.: 13/515,068

(22) PCT Filed: Dec. 21, 2009
(86) PCT No.: PCT/EP09/67617

§ 371 Date: Jun. 11, 2012

(51) Int. Cl. H04W 72/04; H04W 52/24

(52) U.S. Cl. 370/329

(57) ABSTRACT

When resources reserved for the purpose of transmitting control information relating to transmissions between an access node and any one of a plurality of communication devices served by the access node are identified as resources that are not required for said purpose, transmitting via said resources a data sequence recognisable by each communication device served by said access node as not being control information for said respective communication device.

The present invention relates to a technique for use in a communication system in an access node sends to one or more communication devices control information for transmissions made between said access node and said one or more communication devices.

A communication device can be understood as a device provided with appropriate communication and control capabilities for enabling use thereof for communication with others parties. The communication may comprise, for example, communication of voice, electronic mail (email), text messages, data, multimedia and so on. A communication device typically enables a user of the device to receive and transmit communication via a communication system and can thus be used for accessing various service applications.

A communication system is a facility which facilitates the communication between two or more entities such as the communication devices, network entities and other nodes. A communication system may be provided by one or more interconnect networks. One or more gateway nodes may be provided for interconnecting various networks of the system. For example, a gateway node is typically provided between an access network and other communication networks, for example a core network and/or a data network.

An appropriate access system allows the communication device to access to the wider communication system. An access to the wider communications system may be provided by means of a fixed line or wireless communication interface, or a combination of these. Communication systems providing wireless access typically enable at least some mobility for the users thereof. Examples of these include wireless communications systems where the access is provided by means of an arrangement of cellular access networks. Other examples of wireless access technologies include different wireless local area networks (WLANs) and satellite based communication systems.

A wireless access system typically operates in accordance with a wireless standard and/or with a set of specifications which set out what the various elements of the system are permitted to do and how that should be achieved. For example, the standard or specification may define if the user, or more precisely user equipment, is provided with a circuit switched bearer or a packet switched bearer, or both. Communication protocols and/or parameters which should be used for the connection are also typically defined. For example, the manner in which communication should be implemented between the user equipment and the elements of the networks and their functions and responsibilities are typically defined by a predefined communication protocol. Such protocols and or parameters further define the frequency spectrum to be used by which part of the communications system, the transmission power to be used etc.

In the cellular systems a network entity in the form of a base station provides a node for communication with mobile devices in one or more cells or sectors. It is noted that in certain systems a base station is called ‘Node B’. Typically the operation of a base station apparatus and other apparatus of an access system required for the communication is controlled by a particular control entity. The control entity is typically interconnected with other control entities of the particular communication network. Examples of cellular access systems include, in order of their evolution, GSM (Global System for Mobile) EDGE (Enhanced Data for GSM Evolution) Radio Access Networks (GERAN), Universal Terrestrial Radio Access Networks (UTRAN) and evolved UTRAN (EUTRAN).

In the Long Term Evolution (LIE) System Release 8, transmissions between an access node are made according to an orthogonal frequency division multiple access (OFDMA) technique or a single carrier frequency division multiple access (SCFDMA) technique. Each transmission is made using a group of orthogonal sub-carriers. In the time domain, the resources are generally divided between time reserved for the transmission of user data between an access node and communication devices served by the access node, and time reserved for the transmission of control information necessary for the access node to serve a plurality of communication devices. For example, the control information includes (i) information indicating to a communication device by which time-frequency resources data intended for said communication device is transmitted by the access node: (ii) information indicating to a communication device which time-frequency resources have been allocated to the receipt at the access node of data from said communication device.

Depending on the extent of the demand for services from an access node, some of the time-frequency resources that are reserved for the purpose of sending from the access node information about the allocation of time-frequency resources to the sending of user data from the access node, or the receipt at the access node of user data, may be not be required for such purpose. One proposal is for the access node to make no transmission at all via such resources. In the other words, the access node makes zero-power transmissions via such resources, by, for example, shifting the power for such transmissions to transmissions sharing the same time resources but using different frequency resources.

There has been identified the problem that where a communication device is monitoring time-frequency resources via which (unknown to said communication device) the access node serving the communication device is making zero-power or relatively low power transmissions (such as when the access node has no control information to transmit on resources reserved for such purpose), there can be a risk of a communication device erroneously interpreting noise detected on said time-frequency resources as control information about the allocation of resources relating to transmissions between it and said access node. This could lead to the following problems (A) and (B).

(A) Where a communication device interprets noise as information about the allocation of resources to the transmission of user data from the access node to the communication device, the communication device will try (unsuccessfully) to decode the signal on what it incorrectly understands to be the time-frequency resources allocated to a downlink transmission to it, and will transmit a negative acknowledgement (NACK) back to the access node. This NACK could cause interference towards the receipt at the access node of a properly scheduled transmission from another communication device.

(B) Where a communication device interprets noise as information about the allocation of resources to the receipt at the access node of user data from the communication device, the communication device will via what it interprets to be frequency-time resources allocated to it transmit user data in its buffer. This will have two effects: (1) such transmission will cause interference towards the receipt at the access node of an uplink transmission from another communication device that is properly scheduled to make a transmission via said time-frequency resources. (2) The communication device will register the data packet as having been transmitted, and when it is subsequently properly scheduled for a transmission, it will detect a New Data Indication (NDI) message and interpret it as an acknowledgement of correct receipt of said data packet. This lost packet (which the communication incorrectly interprets to have been received at the access node) will cause a RLC transmission and corresponding delay.

It is an aim of the present invention to provide a technique aimed at reducing the risk of the occurrence of such problems.

The present invention provides a method, comprising: when resources reserved for the purpose of transmitting control information relating to transmissions between an access node and any one of a plurality of communication devices served by the access node are identified as resources that are not required for said purpose, transmitting via said resources a data sequence recognisable by each communication device served by said access node as not being control information for said respective communication device.

In one embodiment, the method comprises transmitting via said resources a payload addressed to an imaginary communication device.

In one embodiment, said transmitting a payload addressed to an imaginary communication device comprises generating a cyclic redundancy check for said payload, wherein the payload is constructed such that the cyclic redundancy check is the same irrespective of the size of the payload.

In one embodiment, said transmitting a payload addressed to an imaginary communication device comprises generating a cyclic redundancy check for said payload, and masking said cyclic redundancy check with an identification number for said imaginary device.

In one embodiment, the method further comprises transmitting said data sequence at a non-zero transmission power less than a transmission power used to transmit in a common time interval control information to one or more of said plurality of communication devices served by said access node.

In one embodiment, the method further comprises determining said non-zero transmission power taking into account the size of the payload and an estimate of the level of noise at said one or more communication devices served by said access node. In one embodiment, the method further comprises estimating the number of said plurality of communication devices that are configured to be listening for control information on said resources, and determining a transmission power for said data sequence based on said estimate.

The present invention also provides apparatus configured to carry out any of the above methods.

The present invention also provides an apparatus comprising: a processor and memory including computer program code, wherein the memory and the computer program are configured to, with the processor, cause the apparatus at least to carry out any of the above methods.

The present invention also provides a computer program product comprising program code means which when loaded into a computer controls the computer to perform any of the above methods.

Hereunder an embodiment of the present invention will be described, by way of example only, with reference to the following drawings, in which:

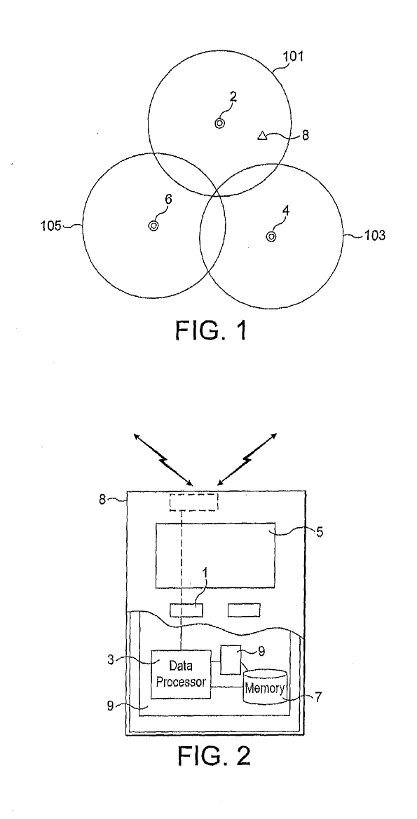

FIG. 1 illustrates a radio access network within which an embodiment of the invention may be implemented, which access network includes a number of cells each served by a respective base station (eNodeB);

FIG. 2 illustrates a user equipment shown in FIG. 1 in further detail.

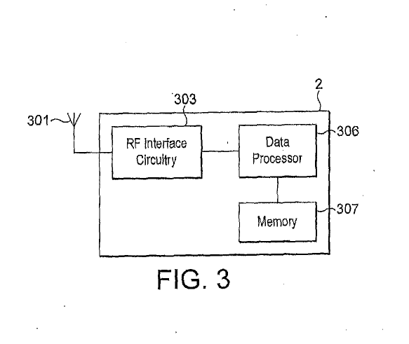

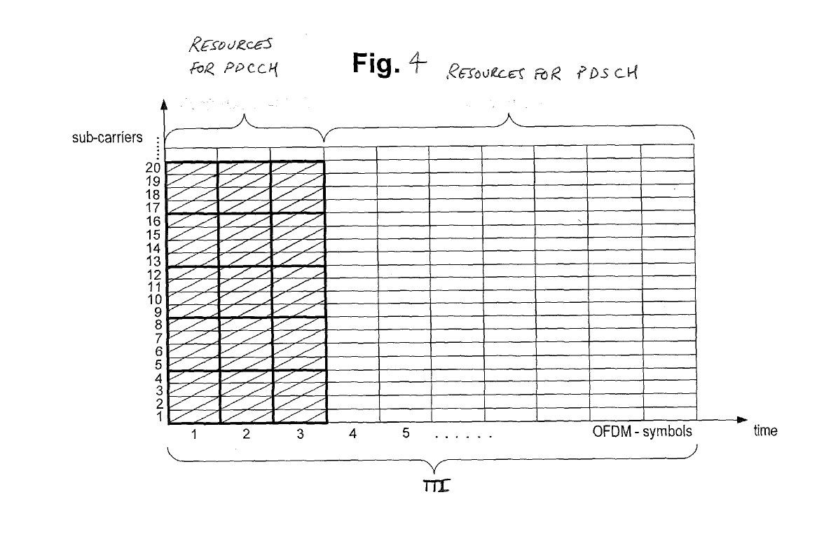

FIG. 3 illustrates an apparatus suitable for implementing an embodiment of the invention at an access node or base station of the radio network shown in FIG. 1;

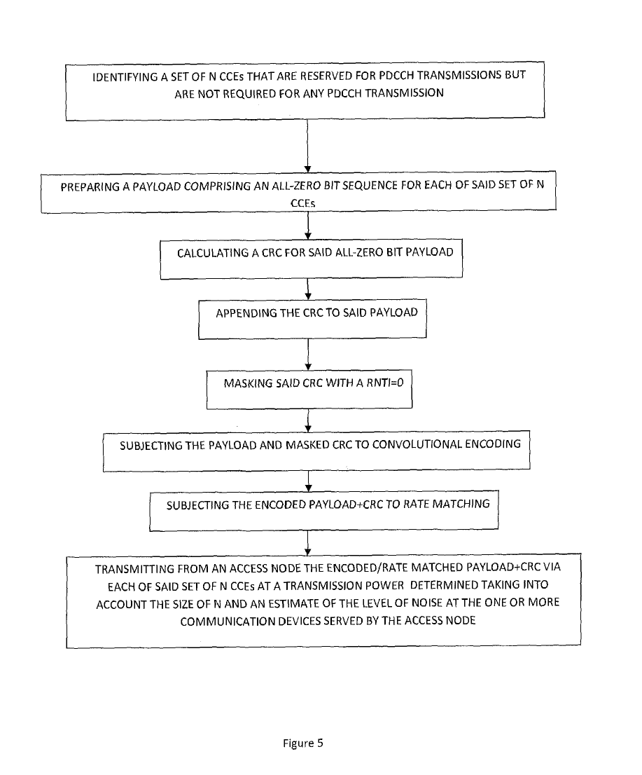

FIG. 4 illustrates the division of time-frequency resources in an embodiment of the present invention; and

FIG. 5 illustrates an example of the operation of an access node in accordance with an embodiment of the present invention.

FIGS. 1, 2 and 3 show respectively the communication system or network, an apparatus for communication within the network, and an access node of the communications network.

FIG. 1 shows a communications system or network comprising a first access node 2 with a first coverage area 101, a second access node 4 with a second coverage area 103 and a third access node 6 with a third coverage area 105. Furthermore FIG. 1 shows user equipment 8 which is configured to communicate with at least one of the access nodes 2, 4, 6. These coverage areas may also be known as cellular coverage areas or cells where the access network is a cellular communications network.

FIG. 2 shows a schematic partially sectioned view of an example of user equipment 8 that may be used for accessing the access nodes and thus the communication system via a wireless interface. The user equipment (UE) 8 may be used for various tasks such as making and receiving phone calls, for receiving and sending data from and to a data network and for experiencing, for example, multimedia or other content.

The UE 8 may be any device capable of at least sending or receiving radio signals. Non-limiting examples include a mobile station (MS), a portable computer provided with a wireless interface card or other wireless interface facility, personal data assistant (PDA) provided with wireless communication capabilities, or any combinations of these or the like. The UE 8 may communicate via an appropriate radio interface arrangement of the UE 8. The interface arrangement may be provided for example by means of a radio part 7 and associated antenna arrangement. The antenna arrangement may be arranged internally or externally to the UE 8.

The UE 8 may be provided with at least one data processing entity 3 and at least one memory or data storage entity 7 for use in tasks it is designed to perform. The data processor 3 and memory 7 may be provided on an appropriate circuit board 9 and/or in chipsets.

The user may control the operation of the UE 8 by means of a suitable user interface such as key pad 1, voice commands, touch sensitive screen or pad, combinations thereof or the like. A display 5, a speaker and a microphone may also be provided. Furthermore, the UE 8 may comprise appropriate connectors (either wired or wireless) to other devices and/or for connecting external accessories, for example hands-free equipment, thereto.

As can be seen with respect to FIG. 1, the UE 8 may be configured to communicate with at least one of a number of access nodes 2, 4, 6, for example when it is located in the coverage area 101 of a first access node 2 the apparatus is configured to be able to communicate to the first access node 2, when in the coverage area 103 of a second node 4 the apparatus may be able to communicate with the second access node 4, and when in the coverage area 105 of the third access node 6 the apparatus may be able to communicate with the third access node 6.

FIG. 3 shows an example of the first access node, which in the embodiment of the invention described below is represented by an evolved node B (eNB) 2. The eNB 2 comprises a radio frequency antenna 301 configured to receive and transmit radio frequency signals, radio frequency interface circuitry 303 configured to interface the radio frequency signals received and transmitted by the antenna 301 and the data processor 167. The radio frequency interface circuitry may also be known as a transceiver. The access node (evolved node B) 2 may also comprise a data processor configured to process signals from the radio frequency interface circuitry 303, control the radio frequency interface circuitry 303 to generate suitable RF signals to communicate information to the UE 8 via the wireless communications link. The access node further comprises a memory 307 for storing data, parameters and instructions for use by the data processor 305.

It would be appreciated that both the UE 8 and access node 2 shown in FIGS. 2 and 3 respectively and described above may comprise further elements which are not directly involved with the embodiments of the invention described hereafter.

An embodiment of the present invention is described below, by way of example only, in the context of a LTE (Long Term Evolution) Advanced system that employs orthogonal sub-carriers for transmissions between a base station (eNodeB) and one or more user equipments served by said eNodeB.

In 3GPP LTE, physical downlink control channels (PDCCH) are used to communicate user equipment (UE)-specific control information to each UE scheduled to receive a downlink (DL) data transmission from an eNodeB or make an uplink (UL) data transmission to an eNodeB in a subsequent transmission time interval (TTI). Reference is made to 3GPP 36.211 for more details.

OFDM defines the multiple access scheme in LTE downlink. With reference to FIG. 4, the OFDM resources comprise a frequency bandwidth divided into orthogonal sub-carriers and a time domain divided into time transmission intervals (TTI) and again into smaller units of time known as OFDM symbols (FIG. 4 only shows 10 OFDM symbols in a TTI, but a TTI typically comprises 14 OFDM symbols). The OFDM resources comprise a large number of resource elements (RE), each RE spanning one sub-carrier and one OFDM symbol in the time domain. PDCCH transmissions are restricted to a limited portion of the OFDM resources that are otherwise used for Physical Downlink Shared Channel (PDSCH) transmissions, i.e. downlink user data transmissions from the eNodeB to one or more of the user equipments. In order to lower the number of allocatable units, a limited number of OFDM symbols in each TTI, e.g. one, two, three or four OFDM symbols of a TTI, are reserved for PDCCH transmissions and therefore a limited number of REs are made available for PDCCH transmissions.

The time-frequency resources generally allocated to PDCCH transmissions and PDSCH transmissions also include REs allocated to the transmission of physical reference signals, but these are not shown in FIG. 4.

The REs made available for PDCCH (shown by diagonal hatching in FIG. 4) are grouped into control channel elements (CCE). Each CCE is built from 9 resource element groups (REG). One REG is constructed from 4 adjacent (or almost adjacent) REs on the same OFDM symbol. The division of the REs into REGs is shown by bold lines in FIG. 4. It can be advantageous for a CCE to be composed of REGs that are widely distributed with a high frequency separation.

For the extreme low bandwidth option of 1.4 MHz system bandwidth, the first four OFDM symbols might be allocated for PDCCH transmissions. The REGs comprising a single CCE may be spread across the frequency spectrum with the aim of obtaining frequency diversity—i.e., targeting averaging performance such that each CCE will potentially provide the same radio channel conditions.

To provide robustness against channel imperfections, a PDCCH is coded using tail-biting convolutional coding prior to transmission. Furthermore, in order to ensure proper coding and transmission, the encoded packet is rate matched to match the available capacity on the physical channel.

As mentioned above, each CCE occupies 36 resource elements. QPSK is used as the modulation scheme, and thus each CCE provides 72 channel bits. In order to provide better flexibility and coverage for the PDCCH, it is possible to apply an operation denoted aggregation, whereby neighbouring CCEs are combined subject to certain limitations. For example, aggregation of two CCEs will improve the link level performance by a bit more than 3 dB (due to the added coding available by having more physical channel resources). Other permitted aggregations for PDCCH are 4 CCEs and 8 CCEs.

As part of the channel coding, a CRC (Cyclic Redundancy check) is attached to the packet to be transmitted before coding and rate-matching. This CRC has the following two uses: (1) it is used to validate the correctness of the received packet at an UE, and (2) it is used to identify the UE to which the packet is addressed. With reference to Sections 5.1.1 and 5.3.3.2 of 3GPP TS 36.212 V.8.7.0, the entire PDCCH payload is used to calculate the CRC parity bits according to a computation set out at Section 5.1.1 of 3GPP TS 36.212. The sequence of CRC parity bits is then appended to the sequence of payload bits, and the sequence of CRC parity bits is scrambled with the RNTI (radio network temporary identifier) of the UE to which the payload is addressed.

Where an access node identifies CCEs that are not needed for any PDCCH transmission to any of the UEs served by the eNB 2 (for conciseness, such CCEs are referred to hereunder as “redundant” CCEs), the eNB 2 fills the redundant CCEs with one or more PDCCHs for an imaginary UE. The bits of the payload of such a PDCCH are all set to zero, and the RNTI used to scramble the CRC is also set to zero. The selection of an all-zero sequence for the payload has the advantage that the resulting sequence of bits after channel coding and rate matching will be all-zero regardless of how many CCES are aggregated to form the PDCCH for the imaginary UE.

A dummy transmission (i.e. a transmission for an imaginary UE) is made for each non-allocated CCE (i.e. each CCE that is not needed for any PDCCH transmission to any of the UEs served by the eNB 2). Due to the special properties of the control channel structure, the aggregation of two neighbouring CCEs would also generate a valid control channel, provided that the CCE index of the aggregated CCE starts at an even index number.

FIG. 5 is a flowchart illustrating the above-described technique employing an all-zero bit sequence for resources where the access node eNB 2 has no control information to send any actual UEs. Due to the linear properties of the convolutional code and the CRC calculation, the resulting codeword is also always all-zero independent of the length of the control information and the code-rate of the convolutional code. This considerably simplifies implementation as no calculations are actually needed.

According to one variation of the above-described technique, a non all-zero sequence that is recognisable by any UE served by eNB 2 as not being control information for it is used instead of the all-zero sequence mentioned above. For example, the sequence might be constructed using an RNTI for an actual UE that eNB 2 knows will not monitor the resources in question.

The actual level of transmission power for a PDCCH for an imaginary UE is ideally selected such that the signal level at which the PDCCH is received at each of the UEs served by the eNodeB 2 is sufficiently high compared to the level of noise at those UEs (i.e. the signal-to-noise ratio (SNR) for the PDCCH at those UEs is sufficiently high) that there is substantially zero probability of any of those UEs served by the eNB 2 interpreting noise detected on said redundant time-frequency resources as control information for that UE. The actual level of transmission power for the PDCCH for an imaginary UE is ideally determined taking into account the code rate (which depends on the CCE aggregation level for the PDCCH for the imaginary UE) and the probability of the UEs served by the eNB 2 being in a certain SNR region (i.e. the level of noise expected for the UEs served by the eNB 2).

The minimum transmission power required for such a PDCCH for an imaginary UE decreases with the level of CCE aggregation; i.e. the minimum transmission power is lowest for an aggregation level of 8 and highest for an aggregation level of 1.

It may be difficult or close to impossible to estimate the SINR of UEs potentially listening for PDCCH transmission on the resources via which (unknown to the UEs) the access node is making the above-described dummy transmissions. Alternative options include: (a) distributing transmission power evenly across all dummy transmissions sharing the same time resources; or (b) estimating the number of listening UEs for each CCE via which a dummy transmission is to be made, and allocating different amounts of transmission power to the dummy transmissions according to the respective estimated number of listening UEs (i.e. allocating most transmission power to the dummy transmission(s) made via resources for which the estimated number of listening UEs is greatest).

Where it happens that a PDCCH for an imaginary UE is to be transmitted at a non-zero power less than the transmission power used to transmit PDCCH for actual UEs in the same transmission time interval, the excess power can be shifted to transmissions addressed to actual UEs allowing more power control of the PDCCH for these actual UEs.

Where a UE 8 detects the all-zero data sequence mentioned above during a search space defined for it in accordance with Section 9.1.1 of 3GPP TS 36.213, the UE will recognise the data sequence as a PDCCH that is not intended for it.

The probability of a receiver falsely detecting invalid information as valid depends on the CRC-polynom type, the length of the CRC as well as the signal to noise ratio (SNR) at the receiver. For communication standards, usually “good” CRC-polynomials are chosen, which means that the probability to detect an invalid packet as valid decreases monotonically as the SNR increases. However, when receiving noise (or more generally a packet with random bits) the probability that a receiver falsely detects noise as a packet with a valid CRC is independent of the SNR and always =1/(2^{N}), which is higher than when receiving a valid codeword.

The technique described above is aimed at ensuring that a UE will receive a valid code word (with low but still detectable signal power) instead of noise in positions (i.e. time-frequency combinations) where the UE is listening for control information but the access node eNB 2 is not transmitting control information for any actual UEs served by the access node eNB 2, and thereby decrease the probability of false detection. The above-described operations may require data processing in the various entities. The data processing may be provided by means of one or more data processors. Similarly various entities described in the above embodiments may be implemented within a single or a plurality of data processing entities and/or data processors. Appropriately adapted computer program code product may be used for implementing the embodiments, when loaded to a computer. The program code product for providing the operation may be stored on and provided by means of a carrier medium such as a carrier disc, card or tape. A possibility is to download the program code product via a data network. Implementation may be provided with appropriate software in a server.

For example the embodiments of the invention may be implemented as a chipset, in other words a series of integrated circuits communicating among each other. The chipset may comprise microprocessors arranged to run code, application specific integrated circuits (ASICs), or programmable digital signal processors for performing the operations described above.

Embodiments of the invention may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

In addition to the modifications explicitly mentioned above, it will be evident to a person skilled in the art that various other modifications of the described embodiment may be made within the scope of the invention.

1-16. (canceled)

17. A method, comprising: identifying resources reserved for the purpose of transmitting control information relating to transmissions between an access node and any one of a plurality of communication devices served by the access node that are not required for said purpose; and transmitting via said resources a data sequence recognisable by each communication device served by said access node as not being control information for said respective communication device.

18. The method according to claim 17, further comprising transmitting via said resources a payload addressed to an imaginary communication device.

19. The method according to claim 18, wherein said transmitting a payload addressed to an imaginary communication device comprises generating a cyclic redundancy check for said payload, wherein the payload is constructed such that the cyclic redundancy check is the same irrespective of the size of the payload.

20. The method according to claim 18, wherein said transmitting a payload addressed to an imaginary communication device comprises generating a cyclic redundancy check for said payload, and masking said cyclic redundancy check with an identification number for said imaginary device.

21. The method according to claim 17, further comprising transmitting said data sequence at a non-zero transmission power less than a transmission power used to transmit in a common time interval control information to one or more of said plurality of communication devices served by said access node.

22. The method according to claim 21, further comprising determining said non-zero transmission power taking into account the size of a payload transmitted via said resources and an estimate of the level of noise at said one or more communication devices served by said access node.

23. The method according to claims 17, further comprising estimating the number of said plurality of communication devices that are configured to be listening for control information on said resources, and determining a transmission power for said data sequence based on said estimate.

24. An apparatus comprising at least one processor; and at least one memory including computer program code; the at least one memory and the computer program code configured to, with the at least one processor, cause the apparatus at least to: identify resources reserved for the purpose of transmitting control information relating to transmissions between an access node and any one of a plurality of communication devices served by the access node as resources that are not required for said purpose; and transmit via said resources a data sequence recognisable by each communication device served by said access node as not being control information for said respective communication device.

25. The apparatus according to claim 24, the at least one memory and the computer program code configured to, with the at least one processor, cause the apparatus further at least to: transmit via said resources a payload addressed to an imaginary communication device.

26. The apparatus according to claim 25, the at least one memory and the computer program code configured to, with the at least one processor, cause the apparatus further at least to: generate a cyclic redundancy check for said payload, wherein the payload is constructed such that the cyclic redundancy check is the same irrespective of the size of the payload.

27. The apparatus according to claim 25, the at least one memory and the computer program code configured to, with the at least one processor, cause the apparatus further at least to: generate a cyclic redundancy check for said payload and mask said cyclic redundancy check with an identification number for said imaginary device.

28. The apparatus according to claim 24, the at least one memory and the computer program code configured to, with the at least one processor, cause the apparatus further at least to: transmit said data sequence at a non-zero transmission power less than a transmission power used to transmit in a common time interval control information to one or more of said plurality of communication devices served by said access node.

29. The apparatus according to claim 28 the at least one memory and the computer program code configured to, with the at least one processor, cause the apparatus further at least to: determine said non-zero transmission power taking into account the size of a payload transmitted via said resources and an estimate of the level of noise at said one or more communication devices served by said access node.

30. The apparatus according to claim 24, the at least one memory and the computer program code configured to, with the at least one processor, cause the apparatus further at least to: estimate the number of said plurality of communication devices that are configured to be listening for control information on said resources, and determine a transmission power for said data sequence based on said estimate.

31. A computer program product comprising program code which when loaded into a computer controls the computer to: identify resources reserved for the purpose of transmitting control information relating to transmissions between an access node and any one of a plurality of communication devices served by the access node that are not required for said purpose; and transmit via said resources a data sequence recognisable by each communication device served by said access node as not being control information for said respective communication device.

32. The computer program product according to claim 31, which when loaded into a computer controls the computer controls the computer further to: transmit via said resources a payload addressed to an imaginary communication device.

33. The computer program product according to claim 32, wherein said transmitting a payload addressed to an imaginary communication device comprises generating a cyclic redundancy check for said payload, wherein the payload is constructed such that the cyclic redundancy check is the same irrespective of the size of the payload.

34. The computer program product according to claim 32, wherein said transmitting a payload addressed to an imaginary communication device comprises generating a cyclic redundancy check for said payload, and masking said cyclic redundancy check with an identification number for said imaginary device.

35. The computer program product according to claim 31, which when loaded into a computer controls the computer further to: transmit said data sequence at a non-zero transmission power less than a transmission power used to transmit in a common time interval control information to one or more of said plurality of communication devices served by said access node.

36. The computer program product according to claim 31, which when loaded into a computer controls the computer further to: estimate the number of said plurality of communication devices that are configured to be listening for control information on said resources, and determine a transmission power for said data sequence based on said estimate.
